(19) United States
(12) Patent Application Publication
(10) Pub. No.: US 2026/0061931 A1
(43) Pub. Date: Mar. 5, 2026

(54) Vehicle U-Turn Indicator Light Device

(71) Applicant: Sheila Harding, Paramount, CA (US)

(72) Inventor: Sheila Harding, Paramount, CA (US)

(21) Appl. No.: 19/295,826

(22) Filed: Aug. 11, 2025

Related U.S. Application Data
(60) Provisional application No. 63/690,870, filed on Sep. 5, 2024.

(51) Int. Cl. B60Q 1/38; B60Q 1/26; B60Q 1/34

(52) U.S. Cl. CPC B60Q 1/38; B60Q 1/2665; B60Q 1/343; B60Q 2900/10

(57) ABSTRACT

A vehicle U-turn indicator light device is disclosed, which is a notification system for vehicles signaling a U-turn. The vehicle U-turn indicator light device comprises an indicator light for a vehicle that displays a U-turn arrow light as opposed to an ordinary turn signal. The device includes the installation of a toggle button on the blinker, either on the side or top of the blinker arm. When the vehicle operator needs to indicate a U-turn, he/she may press the toggle button to activate it. The lights blink before turning to a solid blinking light and are placed on the driver's side of the vehicle.

### CROSS-REFERENCE TO RELATED APPLICATION

The present application claims priority to, and the benefit of, U.S. Provisional Application No. 63/690,870, which was filed on Sep. 5, 2024, and is incorporated herein by reference in its entirety.

### FIELD OF THE INVENTION

The present invention relates generally to the field of vehicle U-turn indicator light devices. More specifically, the present invention relates to a U-turn signaling device that can be integrated into new vehicles or installed as an aftermarket series of attachments. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in vehicle U-turn indicator light devices. Generally, making a U-turn in a vehicle can be a dangerous traffic maneuver, especially if other motorists are unaware that the U-turn is occurring. Making left turns is a simple maneuver that can be sped up to get out of the path of traffic, but when making a U-turn, motorists are cutting across two or more lanes heading in the opposite direction. Getting rear-ended while making a U-turn can lead to severe, long-lasting injuries and significant damage to the vehicle.

It is well known to drivers of motor vehicles that making a U-turn in heavy traffic often poses risks for accidents, because drivers of other vehicles other than that of the driver making a U-turn, do not know in advance if the person making the turn intends to make just a left hand turn or intends to make a complete U-turn. Thus, it is desired to provide a simple, inexpensive and easy-to-use signaling device for clearly signaling to vehicles coming from behind or in front, of a driver's intention to make a U-turn.

Accordingly, there is a demand for an improved vehicle U-turn indicator light device that provide users with a U-turn signaling device that can be integrated into new vehicles or installed as an aftermarket series of attachments. More particularly, there is a demand for a vehicle U-turn indicator light device that features an activation button installed on a vehicle's turn signal that can activate one or more U-turn signaling lights.

Therefore, there exists a long felt need in the art for a vehicle U-turn indicator light device that provides users with a U-turn signaling device that can be integrated into new vehicles or installed as an aftermarket series of attachments. There is also a long felt need in the art for a vehicle U-turn indicator light device that features an activation button installed on a vehicle's turn signal that can activate one or more U-turn signaling lights. Further, there is a long felt need in the art for a vehicle U-turn indicator light device that allows users to notify other motorists of their U-turn maneuver via easily visible lights on the vehicle's brake lights, side mirrors, front headlights, and other areas. Moreover, there is a long felt need in the art for a device that reduces the chance of a dangerous U-turn maneuver causing rear-end collisions. Further, there is a long felt need in the art for a vehicle U-turn indicator light device that minimizes risk when driving and improves driver awareness on the roadways. Finally, there is a long felt need in the art for a vehicle U-turn indicator light device that includes a fuse plug for older vehicles which would plug into the thermal flasher of the blinker system.

The subject matter disclosed and claimed herein, in one embodiment thereof, comprises a vehicle U-turn indicator light device. The device is a notification system for vehicles signaling a U-turn. The vehicle U-turn indicator light device comprises an indicator light for a vehicle that displays a U-turn arrow light as opposed to an ordinary turn signal. The device includes the installation of a toggle button on the blinker, either on the side or top of the blinker arm. When the vehicle operator needs to indicate a U-turn, he/she may press the toggle button to activate it.

Further, the animated lights blink before turning to a solid blinking U-turn blinking light. The U-turn indicator is placed on the driver's side of the vehicle. It can be visible on the left-hand blinker light, the outside left mirror of the vehicle with the wording U-turn, blinking arrows on the left side bumper to signal to the motorist making a right hand turn, and on the left front bumper to signal to oncoming traffic. The motorist may purchase a fuse plug for older vehicles which would plug into the thermal flasher of the blinker device. The plug will have the same features as the vehicle U-turn indicator light device.

In this manner, the vehicle U-turn indicator light device of the present invention accomplishes all of the forgoing objectives and provides users with a device that allows users to notify other motorists of their U-turn maneuver via easily visible lights on the vehicle. The device is an indicator light for a vehicle. The device can be integrated into new vehicles or installed as an aftermarket series of attachments.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle U-turn indicator light device. The device is a notification system for vehicles signaling a U-turn. The vehicle U-turn indicator light device comprises an indicator light for a vehicle that displays a U-turn arrow light as opposed to an ordinary turn signal.

In one embodiment, the vehicle U-turn indicator light device that allows users to notify other motorists of their U-turn maneuver via easily visible lights on the vehicle's driver's side. Thus, the device reduces the chance of a dangerous U-turn maneuver causing rear-end collisions. Accordingly, the vehicle U-turn indicator light device minimizes risk when driving and improves driver awareness on the roadways.

In one embodiment, the vehicle U-turn indicator light device is used to inform motorists, cyclists and pedestrians of a user's intent to make a U-turn with many types of vehicles, such as cars, trucks, campers, RVs, buses, etc., and should not be limited to any particular type of vehicle described herein.

In one embodiment, the vehicle U-turn indicator light device comprises a U-turn arrow light or other suitable signal light having a U-turn symbol incorporated within it, as is known in the art is displayed on the vehicle to inform other motorists of the vehicle's intent to make a U-turn. The U-turn arrow light can be any suitable size and shape as is known in the art but is typically the size and shape of a conventional blinker light on a vehicle. Once activated, the oncoming vehicles and those vehicles in the rear can clearly see the intent of the driver, avoiding what could be a potential accident.

In one embodiment, the U-turn arrow light comprises words and/or symbols signifying a U-turn. Typically, the words and/or symbols are illuminated via a plurality of light emitting diodes (LEDs), which provide illumination and blinking to signal the intention of the user in making a U-turn. The LED lights may operate in one of a continuous, sequential, simultaneous or combination of lighting configurations depending on the preferences of the user. Accordingly, the LED lights may blink in a continuous, sequential or other desired manner in a first direction starting from a first end towards the second arrow end to indicate a U-turn. Further, in one embodiment, the LEDs of the U-turn arrow light typically blink before turning into a solid light. In another embodiment, once activated the LEDs of the U-turn arrow light start as fast blinking lights and then turn into slower blinking lights or vice versa.

In one embodiment, the U-turn arrow light is used when making a U-turn and is located on the front and/or rear of the left side (i.e., driver's side) of the vehicle. For example, the U-turn arrow light can be visible on the left-hand blinker light at the front and/or rear of the vehicle, the outside left mirror of the vehicle with the wording U-turn, blinking arrows on the left side rear bumper to signal to a motorist making a right hand turn, and/or on the left front bumper to signal to oncoming traffic, as well as any other suitable position on the vehicle as is known in the art and depending on the needs and/or wants of a user.

In one embodiment, the vehicle U-turn indicator light device is activated by the vehicle's user by means of pressing a toggle button on the blinker arm of the vehicle. Specifically, the installation of a toggle button on the blinker arm is positioned on either the side or top of the blinker arm, depending on the needs and/or wants of a user. When the vehicle user needs to indicate a U-turn, he/she may press the toggle button to activate one or more U-turn arrow lights. Pressing the toggle button illuminates the U-turn arrow lights. Specifically, the U-turn arrow light includes an ambient light source which provides visibility during day light and night time hours.

In one embodiment, the U-turn arrow light comprises any needed circuitry and wiring to connect it to the vehicle system, such that when activated by the toggle button it illuminates like a conventional blinker. Specifically, the toggle button on the blinker arm is connected to a U-turn electronic switch positioned in the Controller Area Network (CAN) of the vehicle. The switch is coupled to the battery of the vehicle for activating the U-turn arrow lights on the rear and/or front and/or side mirrors of the vehicle.

In one embodiment, the vehicle U-turn indicator light device is integrated directly into new vehicles at the point of manufacture or retrofitted in an existing vehicle body. Further, when the vehicle U-turn indicator light device is retrofitted in an existing vehicle, then, the U-turn electronic switch is connected to the existing CAN of the vehicle and the toggle buttons are mounted to the blinker arm or dashboard.

In another embodiment, the vehicle U-turn indicator light device is installed as an aftermarket series of attachments. For example, the user may purchase a fuse plug for older vehicles which would plug into a thermal flasher of the blinker device of the vehicle. The plug will have the same features as the vehicle U-turn indicator light device and operate in the same manner. If an aftermarket attachment, the U-turn arrow light can be removably or permanently mounted to the front, rear, and/or side mirror, etc., of the vehicle. A conventional fastening mechanism such as mechanical fasteners, adhesive, etc., or any other suitable fastening means can be used for mounting the U-turn arrow light.

In yet another embodiment, the vehicle U-turn indicator light device comprises a plurality of indicia.

In yet another embodiment, a method of signaling a U-turn on a vehicle via an indicator light is disclosed. The method includes the steps of providing a vehicle U-turn indicator light device comprising a U-turn arrow light controlled by a toggle button on the blinker. The method also comprises integrating the device into new vehicle or as an aftermarket series of attachments. Further, the method comprises installing a toggle button on the blinker to control the U-turn arrow light. The method also comprises positioning the U-turn arrow light on the driver's side of the vehicle. Finally, the method comprises pressing the toggle button to activate the U-turn arrow light when the driver needs to indicate a U-turn.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the vehicle U-turn indicator light device of the present invention showing the U-turn signal light on the front headlight area of the vehicle in accordance with the disclosed architecture;

FIG. 2 illustrates a perspective view of one embodiment of the vehicle U-turn indicator light device of the present invention showing the U-turn signal light on the front area of the side mirror in accordance with the disclosed architecture;

FIG. 3 illustrates a perspective view of one embodiment of the vehicle U-turn indicator light device of the present invention showing the U-turn signal light on the rear area of the side mirror in accordance with the disclosed architecture;

FIG. 4 illustrates a perspective view of one embodiment of the vehicle U-turn indicator light device of the present invention showing the activation buttons available on the blinker in accordance with the disclosed architecture;

FIG. 5 illustrates a perspective view of one embodiment of the vehicle U-turn indicator light device of the present invention showing the U-turn signal light shown on the rear brake lights of the vehicle in accordance with the disclosed architecture; and

FIG. 6 illustrates a flowchart showing the method of signaling a U-turn on a vehicle via an indicator light in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a vehicle U-turn indicator light device that provides users with a U-turn signaling device that can be integrated into new vehicles or installed as an aftermarket series of attachments. There is also a long felt need in the art for a vehicle U-turn indicator light device that features an activation button installed on a vehicle's turn signal that can activate one or more U-turn signaling lights. Further, there is a long felt need in the art for a vehicle U-turn indicator light device that allows users to notify other motorists of their U-turn maneuver via easily visible lights on the vehicle's brake lights, side mirrors, front headlights, and other areas. Moreover, there is a long felt need in the art for a device that reduces the chance of a dangerous U-turn maneuver causing rear-end collisions. Further, there is a long felt need in the art for a vehicle U-turn indicator light device that minimizes risk when driving and improves driver awareness on the roadways. Finally, there is a long felt need in the art for a vehicle U-turn indicator light device that includes a fuse plug for older vehicles which would plug into the thermal flasher of the blinker system.

The present invention, in one exemplary embodiment, is a novel vehicle U-turn indicator light device. The device comprises an indicator light for a vehicle that displays a U-turn arrow light as opposed to an ordinary turn signal. The device includes the installation of a toggle button on the blinker, either on the side or top of the blinker arm. When the vehicle operator needs to indicate a U-turn, he/she may press the toggle button to activate it. Further, the animated lights blink before turning to a solid U-turn light. The U-turn indicator is placed on various places on the driver's side of the vehicle. The present invention also includes a novel method of signaling a U-turn on a vehicle via an indicator light. The method includes the steps of providing a vehicle U-turn indicator light device comprising a U-turn arrow light controlled by a toggle button on the blinker. The method also comprises integrating the device into new vehicle or as an aftermarket series of attachments. Further, the method comprises installing a toggle button on the blinker to control the U-turn arrow light. The method also comprises positioning the U-turn arrow light on the driver's side of the vehicle. Finally, the method comprises pressing the toggle button to activate the U-turn arrow light when the driver needs to indicate a U-turn.

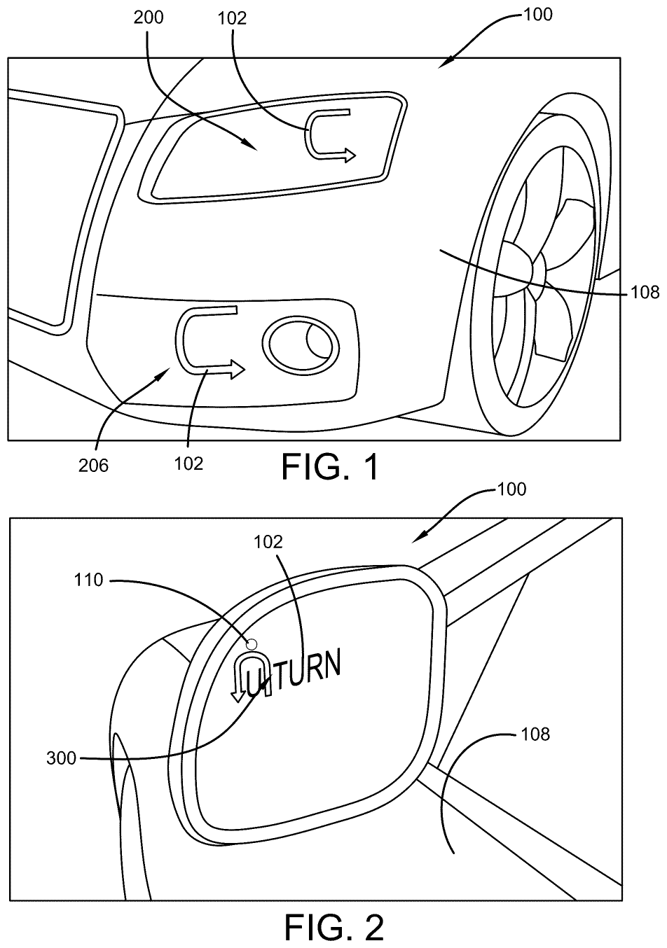

Referring initially to the drawings, FIG. 1 illustrates a perspective view of one embodiment of the vehicle U-turn indicator light device 100 of the present invention. In the present embodiment, the vehicle U-turn indicator light device 100 is an improved vehicle U-turn indicator light device 100 that provides a user with a notification system for signaling a U-turn. Specifically, the vehicle U-turn indicator light device 100 comprises a U-turn arrow light 102 activated by a toggle button 104 on the blinker arm 106.

Generally, the vehicle U-turn indicator light device 100 that allows users to notify other motorists of their U-turn maneuver via easily visible lights on the vehicle's driver's side. Thus, the device 100 reduces the chance of a dangerous U-turn maneuver causing rear-end collisions. Accordingly, the vehicle U-turn indicator light device 100 minimizes risk when driving and improves driver awareness on the roadways.

Typically, the vehicle U-turn indicator light device 100 is used to inform motorists, cyclists and pedestrians of a user's intent to make a U-turn with many types of vehicles 108, such as cars, trucks, campers, RVs, buses, etc., and should not be limited to any particular type of vehicle 108 described herein.

Further, the vehicle U-turn indicator light device 100 comprises a U-turn arrow light 102 or other suitable signal light having a U-turn symbol incorporated within it, as is known in the art is displayed on the vehicle 108 to inform other motorists of the vehicle's intent to make a U-turn. The U-turn arrow light 102 can be any suitable size and shape as is known in the art but is typically the size and shape of a conventional blinker light on a vehicle 108. Once activated, the oncoming vehicles 108 and those vehicles 108 in the rear can clearly see the intent of the driver, avoiding what could be a potential accident.

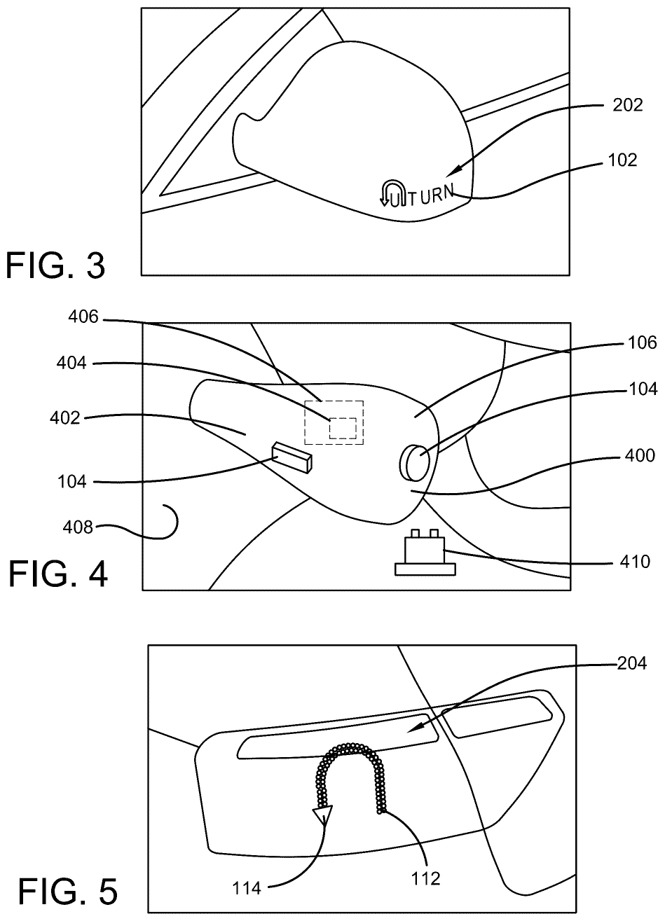

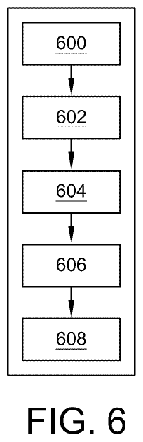

As shown in FIGS. 1-3 and 5, the U-turn arrow light 102 comprises words and/or symbols signifying a U-turn. Typically, the words and/or symbols are illuminated via a plurality of light emitting diodes (LEDs) 110, which provide illumination and blinking to signal the intention of the user in making a U-turn. The LED lights 110 may operate in one of a continuous, sequential, simultaneous or combination of lighting configurations depending on the preferences of the user. Accordingly, the LED lights 110 may blink in a continuous, sequential or other desired manner in a first direction starting from a first end 112 towards the second arrow end 114 to indicate a U-turn. Further, in one embodiment, the LEDs 110 of the U-turn arrow light 102 typically blink before turning into a solid light. In another embodiment, once activated the LEDs 110 of the U-turn arrow light 102 start as fast blinking lights and then turn into slower blinking lights or vice versa.

Further, the U-turn arrow light 102 is used when making a U-turn and is located on the front and/or rear of the left side (i.e., driver's side) of the vehicle. For example, the U-turn arrow light 102 can be visible on the left-hand blinker light 200 at the front and/or rear of the vehicle 108, the outside left mirror 202 of the vehicle 108 with the wording U-turn, blinking arrows on the left side rear bumper 204 to signal to a motorist making a right hand turn, and/or on the left front bumper 206 to signal to oncoming traffic, as well as any other suitable position on the vehicle 108 as is known in the art and depending on the needs and/or wants of a user.

In yet another embodiment, the vehicle U-turn indicator light device 100 comprises a plurality of indicia 300. The U-turn arrow light 102 of the device 100 may include advertising, a trademark, or other letters, designs, or characters, printed, painted, stamped, or integrated into the U-turn arrow light 102, or any other indicia 300 as is known in the art. Specifically, any suitable indicia 300 as is known in the art can be included, such as but not limited to, patterns, logos, emblems, images, symbols, designs, letters, words, characters, animals, advertisements, brands, etc., that may or may not be U-turn, vehicle, or brand related.

As shown in FIG. 4, the vehicle U-turn indicator light device 100 is activated by the vehicle's user by means of pressing a toggle button 104 on the blinker arm 106 of the vehicle 108. Specifically, the installation of a toggle button 104 on the blinker arm 106 is positioned on either the side 400 or top 402 of the blinker arm 106, depending on the needs and/or wants of a user. When the vehicle user needs to indicate a U-turn, he/she may press the toggle button 104 to activate one or more U-turn arrow lights 102. Pressing the toggle button 104 illuminates the U-turn arrow lights 102. Specifically, the U-turn arrow light 102 includes an ambient light source which provides visibility during day light and night time hours.

Further, the U-turn arrow light 102 comprises any needed circuitry and wiring to connect it to the vehicle system, such that when activated by the toggle button 104 it illuminates like a conventional blinker. Specifically, the toggle button 104 on the blinker arm 106 is connected to a U-turn electronic switch 404 positioned in the Controller Area Network (CAN) 406 of the vehicle 108. The switch 404 is coupled to the battery (not shown) of the vehicle 108 for activating the U-turn arrow lights 102 on the rear 204 and/or front 206 and/or side mirrors 202 of the vehicle 108.

In one embodiment, the vehicle U-turn indicator light device 100 is integrated directly into new vehicles at the point of manufacture or retrofitted in an existing vehicle body. Further, when the vehicle U-turn indicator light device 100 is retrofitted in an existing vehicle, then, the U-turn electronic switch 404 is connected to the existing CAN 406 of the vehicle 108 and the toggle buttons 104 are mounted to the blinker arm 106 or dashboard 408.

In another embodiment, the vehicle U-turn indicator light device 100 is installed as an aftermarket series of attachments. For example, the user may purchase a fuse plug 410 for older vehicles which would plug into a thermal flasher (not shown) of the blinker device of the vehicle 108. The plug 410 will have the same features as the vehicle U-turn indicator light device 100 and operate in the same manner. If an aftermarket attachment, the U-turn arrow light 102 can be removably or permanently mounted to the front 206, rear 204, and/or side mirror 202, etc., of the vehicle 108. A conventional fastening mechanism such as mechanical fasteners, adhesive, etc., or any other suitable fastening means can be used for mounting the U-turn arrow light 102.

FIG. 6 illustrates a flowchart of the method of signaling a U-turn on a vehicle via an indicator light. The method includes the steps of at 600, providing a vehicle U-turn indicator light device comprising a U-turn arrow light controlled by a toggle button on the blinker. The method also comprises at 602, integrating the device into new vehicle or as an aftermarket series of attachments. Further, the method comprises at 604, installing a toggle button on the blinker to control the U-turn arrow light. The method also comprises at 606, positioning the U-turn arrow light on the driver's side of the vehicle. Finally, the method comprises at 608, pressing the toggle button to activate the U-turn arrow light when the driver needs to indicate a U-turn.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “vehicle U-turn indicator light device”, “indicator light device”, “vehicle U-turn device”, and “device” are interchangeable and refer to the vehicle U-turn indicator light device 100 of the present invention.

Notwithstanding the forgoing, the vehicle U-turn indicator light device 100 of the present invention can be of any suitable size and configuration as is known in the art without affecting the overall concept of the invention, provided that it accomplishes the above stated objectives. One of ordinary skill in the art will appreciate that the vehicle U-turn indicator light device 100 as shown in FIGS. 1-6 is for illustrative purposes only, and that many other sizes and shapes of the vehicle U-turn indicator light device 100 are well within the scope of the present disclosure. Although the dimensions of the vehicle U-turn indicator light device 100 are important design parameters for user convenience, the vehicle U-turn indicator light device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle U-turn indicator light device that provides a user with a notification system for signaling a U-turn, the vehicle U-turn indicator light device comprising:
a U-turn arrow light; and
a toggle button; and
wherein the U-turn arrow light is activated by the toggle button;
wherein the toggle button is positioned on a blinker arm; and
further wherein the U-turn arrow light is displayed on a vehicle to inform other motorists of a vehicle's intent to make a U-turn.

2. The vehicle U-turn indicator light device of claim 1, wherein the U-turn arrow light is utilized with many types of vehicles, such as cars, trucks, campers, RVs, or buses.

3. The vehicle U-turn indicator light device of claim 2, wherein the U-turn arrow light includes a signal light with a U-turn symbol incorporated within it.

4. The vehicle U-turn indicator light device of claim 3, wherein the U-turn arrow light comprises words and symbols signifying a U-turn.

5. The vehicle U-turn indicator light device of claim 4, wherein the U-turn arrow light is illuminated via a plurality of light emitting diodes (LEDs), which provide illumination and blinking to signal intention of a user in making a U-turn.

6. The vehicle U-turn indicator light device of claim 5, wherein the plurality of LEDs may operate in one of a continuous, sequential, simultaneous or combination of lighting configurations.

7. The vehicle U-turn indicator light device of claim 6, wherein once activated, the U-turn arrow light typically blinks before turning into a solid light.

8. The vehicle U-turn indicator light device of claim 7, wherein the U-turn arrow light is positioned on a left-hand blinker light at a front or rear of the vehicle.

9. The vehicle U-turn indicator light device of claim 8, wherein the U-turn arrow light is positioned on an outside left mirror of the vehicle with wording U-turn.

10. The vehicle U-turn indicator light device of claim 9, wherein the U-turn arrow light is positioned on a left side rear bumper or on a left front bumper of the vehicle.

11. The vehicle U-turn indicator light device of claim 10 further comprising a plurality of indicia.

12. The vehicle U-turn indicator light device of claim 11, wherein installation of the toggle button is positioned on either the side or top of the blinker arm.

13. The vehicle U-turn indicator light device of claim 12, wherein the U-turn arrow light comprises any needed circuitry and wiring to connect it to the vehicle.

14. The vehicle U-turn indicator light device of claim 13, wherein the toggle button on the blinker arm is connected to a U-turn electronic switch positioned in a Controller Area Network (CAN) of the vehicle to activate the U-turn arrow light.

15. A vehicle U-turn indicator light device that provides a user with a notification system for signaling a U-turn, the vehicle U-turn indicator light device comprising:
a U-turn arrow light comprising words and symbols signifying a U-turn; and
a toggle button;
wherein the U-turn arrow light is activated by the toggle button;
wherein the toggle button is positioned on a side or a top of the blinker arm;
wherein once activated, the U-turn arrow light typically blinks before turning into a solid light;
wherein the U-turn arrow light is positioned on a left-hand blinker light at a front or rear of the vehicle;
wherein the U-turn arrow light is positioned on an outside left mirror of the vehicle with wording U-turn;
wherein the U-turn arrow light is positioned on a left side rear bumper or on a left front bumper of the vehicle;
wherein the U-turn arrow light comprises any needed circuitry and wiring to connect it to the vehicle; and
further wherein the U-turn arrow light is displayed on a vehicle to inform other motorists of a vehicle's intent to make a U-turn.

16. The vehicle U-turn indicator light device of claim 15, wherein the vehicle U-turn indicator light device is integrated directly into new vehicles at a point of manufacture.

17. The vehicle U-turn indicator light device of claim 15, wherein the vehicle U-turn indicator light device is retrofitted in an existing vehicle body.

18. The vehicle U-turn indicator light device of claim 15, wherein a user may purchase a fuse plug for older vehicles which would plug into a thermal flasher of a vehicle blinker.

19. The vehicle U-turn indicator light device of claim 18, wherein the fuse plug has same features as the vehicle U-turn indicator light device and operates in same manner.

20. A method of signaling a U-turn on a vehicle via an indicator light, the method comprising the following steps:
providing a vehicle U-turn indicator light device comprising a U-turn arrow light controlled by a toggle button on the blinker;
integrating the device into new vehicle or as an aftermarket series of attachments;
installing a toggle button on the blinker to control the U-turn arrow light;
positioning the U-turn arrow light on the driver's side of the vehicle; and
pressing the toggle button to activate the U-turn arrow light when the driver needs to indicate a U-turn.
